(19) United States
(12) Patent Application Publication
(10) Pub. No.: US 2024/0398010 A1
(43) Pub. Date: Dec. 5, 2024

(54) AEROSOL DELIVERY COMPONENT

(71) Applicant: Imperial Tobacco Limited, Bristol (GB)

(72) Inventors: Graham Cannell, Liverpool Merseyside (GB); Jonathan Davies, Liverpool Merseyside (GB); Andrew Robert Wallace, Liverpool Merseyside (GB)

(21) Appl. No.: 18/695,341

(22) PCT Filed: Sep. 9, 2022
(86) PCT No.: PCT/EP2022/075182

§ 371 Date: Mar. 25, 2024

(30) Foreign Application Priority Data
Sep. 28, 2021 (EP) 21199501.4

(51) Int. Cl. A24F 40/44; A24F 40/10; A24F 40/46

(52) U.S. Cl. CPC A24F 40/44; A24F 40/10; A24F 40/46

(57) ABSTRACT

Disclosed is an aerosol-delivery component comprising a vaporiser in fluid communication with a reservoir for storing a liquid aerosol precursor and an air flow path extending from an inlet of the component to an outlet of the component. The vaporiser comprises a tubular ceramic wick defining a vaporiser portion of the air flow path through the vaporiser. The vaporiser further comprises a heating element within the vaporiser portion of the air flow path wherein the heating element comprises a sheet of absorbent, electrically-conductive material.

### TECHNICAL FIELD

The present disclosure relates to an aerosol-delivery component (e.g. a smoking substitute component), which may be a consumable for receipt in an aerosol-delivery device to form an aerosol-delivery system (e.g. a smoking substitute system).

### BACKGROUND

The smoking of tobacco is generally considered to expose a smoker to potentially harmful substances. It is generally thought that a significant amount of the potentially harmful substances are generated through the heat caused by the burning and/or combustion of the tobacco and the constituents of the burnt tobacco in the tobacco smoke itself.

Combustion of organic material such as tobacco is known to produce tar and other potentially harmful by-products. There have been proposed various smoking substitute systems in order to avoid the smoking of tobacco.

Such smoking substitute systems can form part of nicotine replacement therapies aimed at people who wish to stop smoking and overcome a dependence on nicotine.

Smoking substitute systems, which may also be known as electronic nicotine delivery systems, may comprise electronic systems that permit a user to simulate the act of smoking by producing an aerosol, also referred to as a “vapour”, which is drawn into the lungs through the mouth (inhaled) and then exhaled. The inhaled aerosol typically bears nicotine and/or flavourings without, or with fewer of, the odour and health risks associated with traditional smoking.

In general, smoking substitute systems are intended to provide a substitute for the rituals of smoking, whilst providing the user with a similar experience and satisfaction to those experienced with traditional smoking and tobacco products.

The popularity and use of smoking substitute systems has grown rapidly in the past few years. Although originally marketed as an aid to assist habitual smokers wishing to quit tobacco smoking, consumers are increasingly viewing smoking substitute systems as desirable lifestyle accessories. Some smoking substitute systems are designed to resemble a traditional cigarette and are cylindrical in form with a mouthpiece at one end. Other smoking substitute systems do not generally resemble a cigarette (for example, the smoking substitute device may have a generally box-like form).

There are a number of different categories of smoking substitute systems, each utilising a different smoking substitute approach. A smoking substitute approach corresponds to the manner in which the substitute system operates for a user.

One approach for a smoking substitute system is the so-called “vaping” approach, in which a vaporisable liquid, typically referred to (and referred to herein) as “e-liquid”, is heated by a heater to produce an aerosol vapour which is inhaled by a user. An e-liquid typically includes a base liquid as well as nicotine and/or flavourings. The resulting vapour therefore typically contains nicotine and/or flavourings. The base liquid may include propylene glycol and/or vegetable glycerine.

A typical vaping smoking substitute system includes a mouthpiece, a power source (typically a battery), a tank or liquid reservoir for containing e-liquid, as well as a heater. In use, electrical energy is supplied from the power source to the heater, which heats the e-liquid to produce an aerosol (or “vapour”) which is inhaled by a user through the mouthpiece.

Vaping smoking substitute systems can be configured in a variety of ways. For example, there are “closed system” vaping smoking substitute systems which typically have a heater and a sealed tank which is pre-filled with e-liquid and is not intended to be refilled by an end user. One subset of closed system vaping smoking substitute systems include a device which includes the power source, wherein the device is configured to be physically and electrically coupled to a consumable component including the tank and the heater. In this way, when the tank of the consumable component has been emptied, the device can be reused by connecting it to a new consumable component. Another subset of closed system vaping smoking substitute systems are completely disposable, and intended for one-use only.

There are also “open system” vaping smoking substitute systems which typically have a tank that is configured to be refilled by a user, so the system can be used multiple times.

An example vaping smoking substitute system is the Myblu™ e-cigarette. The Myblu™ e cigarette is a closed system which includes a device and a consumable component. The device and consumable component are physically and electrically coupled together by pushing the consumable component into the device. The device includes a rechargeable battery. The consumable component includes a mouthpiece, a sealed tank which contains e-liquid, as well as a vaporiser, which for this system is a heating filament coiled around a portion of a wick which is partially immersed in the e-liquid. The system is activated when a microprocessor on board the device detects a user inhaling through the mouthpiece. When the system is activated, electrical energy is supplied from the power source to the vaporiser, which heats e-liquid from the tank to produce a vapour which is inhaled by a user through the mouthpiece.

Another example vaping smoking substitute system is the blu PRO™ e-cigarette. The blu PRO™ e cigarette is an open system which includes a device, a (refillable) tank, and a mouthpiece. The device and tank are physically and electrically coupled together by screwing one to the other. The mouthpiece and refillable tank are physically coupled together by screwing one into the other, and detaching the mouthpiece from the refillable tank allows the tank to be refilled with e-liquid. The system is activated by a button on the device. When the system is activated, electrical energy is supplied from the power source to a vaporiser, which heats e-liquid from the tank to produce a vapour which is inhaled by a user through the mouthpiece.

As the vapour passes through the consumable (entrained in the airflow) from the location of vaporization to an outlet of the consumable (e.g. a mouthpiece), the vapour cools and condenses to form an aerosol for inhalation by the user. The aerosol may contain nicotine and/or flavour compounds.

As described above, known consumables for smoking substitute systems typically include a vaporiser comprising a heating filament which is coiled (e.g., helically coiled) around a portion of a wick, which is partially immersed in the e-liquid. This arrangement can form air gaps, or cavities, between the heating filament and the wick, which can disrupt the transfer of thermal energy from the filament to the e-liquid absorbed in the wick. This leads to inefficient vaporisation of the e-liquid which can cause audible ‘spitting’ noises within the vaporiser that are distracting for the user. In view of the above, it is desirable to improve the vaporisation of e-liquid in consumables for smoking substitute systems.

### SUMMARY

According to a first aspect there is a provided an aerosol-delivery component, comprising: a vaporiser in fluid communication with a reservoir for storing a liquid aerosol precursor and an air flow path extending from an inlet of the component to an outlet of the component. The vaporiser comprises a tubular ceramic wick defining a vaporiser portion of the air flow path. The vaporiser further comprises a heating element within the vaporiser portion of the air flow path, wherein the heating element comprises a sheet of absorbent, electrically-conductive material.

By using a sheet of absorbent, electrically-conductive material as the heating element (i.e. instead of a helically wound coil) and a tubular ceramic wick as a reservoir (i.e., instead of a cotton wick), the aerosol delivery component is able to increase the contact surface between the heating element and wick (e.g., along the axial length of tubular ceramic wick), which leads to increased vaporisation of aerosol precursor. Additionally, the sheet of absorbent, electrically-conductive material may provide a planar flow surface which reduces turbulent airflow through the portion of the air flow path which passes through the tubular ceramic wick. The above technical advantages of the component according to the present disclosure result in a more efficient vaporisation of the aerosol precursor, which reduces the chance of audible ‘spitting’ events in the vaporiser. It also leads to a smoother and more flavour-some tasting vapour for the user.

Optional features will now be set out. These are applicable singly or in any combination with any aspect.

The component may comprise a component housing having an upstream mouthpiece portion and a downstream base portion. The mouthpiece portion and base portion may be integrally formed.

As described above, the heating element is arranged within the air flow path. In particular, the heating element may be arranged within the air flow path that is defined by a bore (e.g., an axial bore) through the tubular ceramic wick. The heating element may be configured to contact an inner circumferential surface of the tubular ceramic wick, to enable a flow of liquid aerosol precursor from the wick to the heating element.

The heating element may be arranged to engage, or abut, the inner circumferential surface of the tubular ceramic wick. Alternatively, or in addition, at least a portion of the heating element may be at least partially embedded within the wick.

The sheet of absorbent, electrically-conductive material may extend axially along the tubular ceramic wick to increase the contact surface with the wick, which thereby leads to an increase in the vaporisation of aerosol precursor within the air flow path. The sheet of absorbent, electrically-conductive material may extend along the entire axial length of the tubular ceramic wick. For example, the sheet may extend from an upstream end to a downstream end of the tubular ceramic wick, thereby further increasing the contact surface between the heating element and the wick.

The sheet of absorbent, electrically-conductive material may comprise a planar sheet, or substrate, having opposing lateral edges. At least one lateral edge of the planar sheet may contact the inner circumferential surface of the wick to form a line contact between the heating element and the wick.

Both lateral edges of the planar sheet may each form separate line contacts with the inner circumferential surface of the wick. One or both of the lateral edges of the planar sheet may be at least partially embedded within the wick to increase the surface contact between wick and the heating element.

The planar sheet comprises a length, a width and a depth. Both the length and the width may be substantially greater than the depth. The length may be greater than the width. The planar sheet may be arranged in the air flow path such that the length of the planar sheet is parallel to the cylindrical axis of the tubular ceramic wick. In this way, the planar sheet may extend transversely across the bore through the tubular ceramic wick i.e., such that the planar sheet is arranged to span across the bore. The planar sheet may be arranged to bisect the air flow path through the wick. This may evenly distribute the airflow either side of the sheet which reduces turbulence of the air flow through the vaporiser.

According to an alternative exemplary arrangement, the sheet may be substantially curved. For example, the sheet may be configured to follow the contour of at least a portion of the inner circumferential surface of the wick. The sheet may form a tubular sheet which is arranged e.g. concentrically arranged within the bore of the tubular ceramic wick. Accordingly, the heating element may comprise a tubular sheet of absorbent, electrically-conductive material. An inner circumferential surface of the tubular sheet may define the air flow path through the vaporiser.

The concentric sheet and the tubular ceramic wick may be coaxially aligned. An outer circumferential surface of the concentric tubular sheet may be arranged to abut the inner circumferential surface of the wick. This arrangement may yet further increase the contact surface between heating element and the wick, thereby increasing the vaporisation of aerosol precursor within the airflow through the vaporiser.

The tubular ceramic wick and the tubular sheet of absorbent, electrically-conductive material may be formed separately and then assembled to form the vaporiser. According to an alternative exemplary arrangement, the outer circumferential surface of the tubular sheet of absorbent, electrically-conductive material may be covered with a ceramic material in order to form the tubular ceramic wick. The ceramic material may be over-moulded and/or cast onto the outer surface of the tubular sheet.

The heating element may be electrically connectable (or connected) to a power source. In particular, the component may comprise an electrical connector for connecting the heating element to the power source. The electrical connector may be configured to mechanically attach directly to the sheet of absorbent, electrically-conductive material to form an electrical connection. For example, the electrical connector may comprise a clip-on portion e.g. a deformable clip-on portion. The electrical connector may be formed of an electrically conductive material, such as a metal, or metallic alloy material.

In arrangements where the heating element comprises a tubular sheet, the clip-on portion of the electrical connector may be configured to mechanically couple the electrical connector to an outer circumferential surface of the tubular sheet. This provides a simple yet secure means of fastening the electrical connector to the tubular sheet. The clip-on portion may comprise a snap-fit fastening, which may comprise a curved arm that extends at least partially around the outer circumferential surface of the tubular sheet.

A first electrical connector may be coupled to an upstream end of the tubular sheet and a second electrical connector may be coupled to a downstream end of the tubular sheet. This ensures electrical current is directed evenly along the entire length of the heating element providing even heating of the aerosol forming liquid in the vaporiser.

The electrical connector may comprise an elongate arm portion which extends, in an axial direction of the tubular sheet, between the outer circumferential surface of the sheet and the inner circumferential surface of the tubular ceramic wick. A distal end of the elongate arm portion may define an electrical contact.

The absorbent, electrically-conductive material may comprise carbon e.g. carbon fibres. The carbon e.g. carbon fibres may be advantageously configured with high electrical conductance. The carbon e.g. carbon fibres may be configured to tolerate the temperatures required to vaporise the aerosol precursor liquid. The carbon fibres may be configured to form a woven material. The woven carbon fibre material may be configured with absorbent, and/or wicking, properties that can be used to control the flow of aerosol precursor liquid from the ceramic wick, and thereby improve the formation of vapour within vaporiser.

According to an exemplary arrangement of the heating element, the absorbent, electrically-conductive material may be configured, e.g. dimensioned, such that it exhibits a resistance value of about 1.4 Ohms under current-voltage conditions of about 2 Amps, and a voltage range of between 3.7 to 4.2 Volts.

As described above, the wick is in the form of a tubular ceramic wick, which defines the air flow path through the vaporiser. The tubular ceramic wick may be porous. The material from which the tubular ceramic wick is formed may comprise aluminium nitride. The wick may comprise a bore having an elliptical (e.g., circular) transverse cross section i.e. transverse to the longitudinal axis of the bore of the tubular wick. The diameter of the bore may be smaller than the axial length of the tubular wick.

The axis of the tubular ceramic wick may extend along a longitudinal axis of the aerosol delivery component. In this way, the wick may be oriented so as to extend in the direction of the length dimension of the component (parallel to the longitudinal axis of the component). Thus, the wick may extend in a direction parallel to the direction of airflow in the airflow path. This orientation of the wick means less turbulent airflow through the vaporiser which therefore increases the vapour delivery efficiency of the component.

The component may further comprise a perforated, or apertured, tube arranged concentrically around and radially outwards of the tubular ceramic wick. The perforated tube may be configured to allow fluid to flow towards the tubular ceramic wick (e.g. towards the outer circumferential surface of the tubular ceramic wick). The perforated tube may be arranged to surround the tubular ceramic wick. The perforated tube may be configured so that an inner circumferential surface of the perforated tube engages, or abuts, the outer circumferential surface of the ceramic tubular wick. The perforated tube may comprise a circumferential wall comprising at least one aperture or perforation and preferably a plurality of apertures or perforations. The perforated tube may comprise a mesh. The perforated tube may be formed from a metallic alloy material, such as stainless steel.

As described above, the component comprises the airflow path that extends from the air inlet to the outlet. The outlet is preferably provided in the mouthpiece portion. In this respect, a user may draw fluid (e.g. air) into and along the airflow path by inhaling at the outlet (i.e. using the mouthpiece portion).

The airflow path passes through the vaporiser between the air inlet and the outlet. Accordingly, the vaporiser may be arranged upstream from the outlet and downstream from the inlet.

The airflow path may comprise a first portion extending from the air inlet towards the vaporiser. A second portion (i.e. the vaporiser portion) of the airflow path may pass through the vaporiser to a conduit that extends to the outlet. A third portion of the airflow path may pass through the conduit to the outlet.

The air flow passing through the vaporiser is directed through tubular wick, which defines the vaporiser portion of the airflow path (i.e., the second portion of the airflow path). Accordingly, the tubular ceramic wick (e.g., an axial bore of the tubular ceramic wick) may define a vaporising chamber of the vaporiser.

References to “downstream” in relation to the airflow path are intended to refer to the direction towards the outlet/mouthpiece portion. Thus the second portion of the airflow path is downstream of the first portion of the airflow path. Conversely, references to “upstream” are intended to refer to the direction towards the air inlet. Thus the first portion of the airflow path (and the air inlet) is upstream of the second portion of the airflow path (and the outlet/mouthpiece portion).

References to “upper”, “lower”, “above” or “below” are intended to refer to the component when in an upright/vertical orientation i.e. with elongate (longitudinal/length) axis of the component vertically aligned and with the mouthpiece vertically uppermost.

References to “downstream” in relation to the air flow path are intended to refer to the direction towards the outlet/mouthpiece portion. Thus the second (vaporiser) and third portions of the air flow path are downstream of the first portion of the air flow path. Conversely, references to “upstream” are intended to refer to the direction towards the air inlet. Thus the first portion of the air flow path (and the air inlet) is upstream of the second (vaporiser)/third portions of the air flow path (and the outlet/mouthpiece portion).

The component may comprise a tank for housing the aerosol precursor (e.g. a liquid aerosol precursor). The aerosol precursor may comprise an e-liquid, for example, comprising a base liquid and e.g. nicotine. The base liquid may include propylene glycol and/or vegetable glycerine.

The conduit may extend along the axial centre of the component. The conduit may extend through the tank with the conduit walls defining an inner region of the tank. In this respect, the tank may surround the conduit e.g. the tank may be annular.

The tank may be defined by one or more side walls (e.g. laterally opposed first and second side walls) extending longitudinally from the mouthpiece portion.

The tank may further comprise opposing front and rear walls spaced by the laterally opposed first and second side walls.

At least a portion of one of the walls defining the tank may be translucent or transparent.

The distance between the first and second side walls may define a width of the tank. The distance between the front and rear walls may define a depth of the tank. The width of the tank may be greater than the depth of the tank.

The length of the tank/component housing may be greater than the width of the tank/component housing. The depth of the tank/component housing may be smaller than each of the width and the length.

The tank walls may be integrally formed and may additionally be integrally formed with the mouthpiece portion. In that way, the component may be easily manufactured using injection moulding.

As discussed above, the air flow path passes the vaporiser between the air inlet and the outlet, and the vaporiser comprises the heating element for heating the wick.

The vaporising chamber may be defined by the tubular wick which defines the vaporiser portion of the airflow path.

A sleeve may be provided to seal the conduit to the tubular wick and/or to the perforated tube.

The perforated tube may be configured to partially separate the wick from the tank. The perforated tube is configured to provide fluid communication between the wick and the tank via the perforation(s) in the perforated tube wall. In this way an exposed portion (e.g. an inner surface) of the wick (i.e. the surface of the axial bore through the wick) may be exposed to air in the vaporiser portion of the airflow path and an outer surface (e.g. an outer circumferential surface) of the wick may be in fluid communication with aerosol precursor/e-liquid stored in the tank via the perforation(s) in the perforated tube. Thus, aerosol precursor/e-liquid may be drawn (e.g. by capillary action) into the wick, from the tank to the exposed portion of the wick. In particular, the aerosol precursor/e-liquid may be drawn from an outer surface to an inner surface of the tubular wick. In addition, the aerosol precursor may be drawn axially along the wick.

The sleeve may partially define the tank. A vent may be provided in the sleeve for the flow of air into the aerosol precursor tank (i.e. so as to allow for pressure equalisation in the tank).

The vaporiser may be arranged (e.g., mounted) in an insert (e.g. an insert at least partially formed of silicone) received into an open (e.g. lower) end of the housing. The insert may at least partially define the (base of the) tank.

As described above, the heating element may be electrically connectable (or connected) to a power source. Thus, in operation, the power source may supply electricity to (i.e. apply a voltage across) the heating element so as to heat the heating element. This may cause liquid stored in the wick (i.e. drawn from the tank) to be heated so as to form a vapour and become entrained in fluid flowing along the airflow path (e.g. the vaporiser portion of the airflow path). This vapour may subsequently cool to form an aerosol in the airflow path (e.g. the third portion of the airflow path).

In a second aspect there is provided an aerosol-delivery system (e.g. a smoking substitute system) comprising a component according to the first aspect and an aerosol-delivery (e.g. smoking substitute) device.

The component may be an aerosol-delivery (e.g. a smoking substitute) consumable i.e. in some embodiments the component may be a consumable component for engagement with the aerosol-delivery (e.g. a smoking substitute) device to form the aerosol-delivery (e.g. s smoking substitute) system.

The device may be configured to receive the consumable component. For example the device and the consumable component may be configured to be physically coupled together. For example, the consumable component may be at least partially received in a recess of the device, such that there is snap engagement between the device and the consumable component. Alternatively, the device and the consumable component may be physically coupled together by screwing one onto the other, or through a bayonet fitting.

Thus, the consumable component may comprise one or more engagement portions for engaging with the device. The consumable component may comprise an electrical interface for interfacing with a corresponding electrical interface of the device. One or both of the electrical interfaces may include one or more electrical contacts. The electrical contacts may be electrically coupled to the electrical connectors which supply power to the heating element, as described above. The electrical contacts and the electrical connectors may be integrally formed. Thus, when the device is engaged with the consumable component, the electrical interface may be configured to transfer electrical power from the power source to a heating element of the consumable component. The electrical interface may also be used to identify the consumable component from a list of known types. The electrical interface may additionally or alternatively be used to identify when the consumable component is connected to the device.

The device may alternatively or additionally be able to detect information about the consumable component via an RFID reader, a barcode or QR code reader. This interface may be able to identify a characteristic (e.g. a type) of the consumable. In this respect, the consumable component may include any one or more of an RFID chip, a barcode or QR code, or memory within which is an identifier and which can be interrogated via the interface.

In other embodiments, the component may be integrally formed with the aerosol-delivery (e.g. a smoking substitute) device to form the aerosol-delivery (e.g. s smoking substitute) system.

In such embodiments, the aerosol former (e.g. e-liquid) may be replenished by re-filling a tank that is integral with the device (rather than replacing the consumable). Access to the tank (for re-filling of the e-liquid) may be provided via e.g. an opening to the tank that is sealable with a closure (e.g. a cap).

Further features of the device are described below. These are applicable to both the device for receiving a consumable component and to the device integral with the component.

The device may comprise a power source e.g. a rechargeable battery. The device may comprise a controller.

A memory may be provided and may be operatively connected to the controller. The memory may include non-volatile memory. The memory may include instructions which, when implemented, cause the controller to perform certain tasks or steps of a method. The device may comprise a wireless interface, which may be configured to communicate wirelessly with another device, for example a mobile device, e.g. via Bluetooth®. To this end, the wireless interface could include a Bluetooth® antenna. Other wireless communication interfaces, e.g. WiFi®, are also possible. The wireless interface may also be configured to communicate wirelessly with a remote server.

An airflow (i.e. puff) sensor may be provided that is configured to detect a puff (i.e. inhalation from a user). The airflow sensor may be operatively connected to the controller so as to be able to provide a signal to the controller that is indicative of a puff state (i.e. puffing or not puffing). The airflow sensor may, for example, be in the form of a pressure sensor or an acoustic sensor. The controller may control power supply to a heating element in response to airflow detection by the sensor. The control may be in the form of activation of the heating element in response to a detected airflow. The airflow sensor may form part of the device.

In a third aspect there is provided a method of using the aerosol-delivery (e.g. smoking substitute) consumable component according to the first aspect, the method comprising engaging the consumable component with an aerosol-delivery (e.g. smoking substitute) device (as described above) having a power source so as to electrically connect the power source to the consumable component (i.e. to the vaporiser of the consumable component).

The invention includes the combination of the aspects and preferred features described except where such a combination is clearly impermissible or expressly avoided.

### BRIEF DESCRIPTION OF THE DRAWINGS

So that further aspects and features thereof may be appreciated, embodiments will now be discussed in further detail with reference to the accompanying figures, in which:

FIG. 1A is a front schematic view of a smoking substitute system;

FIG. 1B is a front schematic view of a device of the system;

FIG. 1C is a front schematic view of a consumable of the system;

FIG. 2A is a schematic of the components of the device;

FIG. 2B is a schematic of the components of the consumable;

FIG. 3 is a front section view of the consumable;

FIG. 4A is a perspective view of a vaporiser arranged within the consumable;

FIG. 4B is a top view of the vaporiser arranged within the consumable;

FIG. 5 is a perspective view of the vaporiser shown in FIGS. 4A and 4B, shown in isolation from the remainder of consumable;

FIGS. 6 and 7 are perspective views of a variation of the vaporiser of FIG. 5, in an unassembled and an assembled state, respectively; and

FIGS. 8 and 9 are perspective views of a heating element of the vaporiser shown in FIGS. 6 and 7, in an unassembled and an assembled state, respectively.

### DETAILED DESCRIPTION OF THE EMBODIMENTS

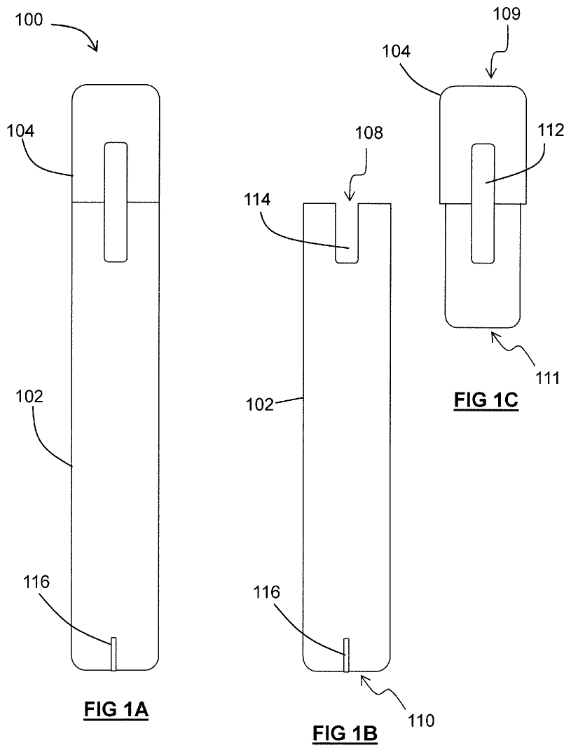

FIG. 1A shows a first embodiment of a smoking substitute system 100. In this example, the smoking substitute system 100 includes a device 102 and a component 104. The component 104 may alternatively be referred to as a “pod”, “cartridge” or “cartomizer”. It should be appreciated that in other examples (i.e. open systems), the device may be integral with the component. In such systems, a tank of the aerosol delivery system may be accessible for refilling the device.

In this example, the smoking substitute system 100 is a closed system vaping system, wherein the component 104 includes a sealed tank 106 and is intended for single-use only. The component 104 is removably engageable with the device 102 (i.e. for removal and replacement). FIG. 1A shows the smoking substitute system 100 with the device 102 physically coupled to the component 104, FIG. 1B shows the device 102 of the smoking substitute system 100 without the component 104, and FIG. 1C shows the component 104 of the smoking substitute system 100 without the device 102.

The device 102 and the component 104 are configured to be physically coupled together by pushing the component 104 into a cavity at an upper end 108 of the device 102, such that there is an interference fit between the device 102 and the component 104. In other examples, the device 102 and the component may be coupled by screwing one onto the other, or through a bayonet fitting.

The component 104 includes a mouthpiece portion at an upper end 109 of the component 104, and one or more air inlets (not shown) in fluid communication with the mouthpiece portion such that air can be drawn into and through the component 104 when a user inhales through the mouthpiece portion. The tank 106 containing e-liquid is located at the lower end 111 of the component 104.

The tank 106 includes a window 112, which allows the amount of e-liquid in the tank 106 to be visually assessed. The device 102 includes a slot 114 so that the window 112 of the component 104 can be seen whilst the rest of the tank 106 is obscured from view when the component 104 is inserted into the cavity at the upper end 108 of the device 102.

The lower end 110 of the device 102 also includes a light 116 (e.g. an LED) located behind a small translucent cover. The light 116 may be configured to illuminate when the smoking substitute system 100 is activated. Whilst not shown, the component 104 may identify itself to the device 102, via an electrical interface, RFID chip, or barcode.

The lower end 110 of the device 102 also includes a charging connection 115, which is usable to charge a battery within the device 102. The charging connection 115 can also be used to transfer data to and from the device, for example to update firmware thereon.

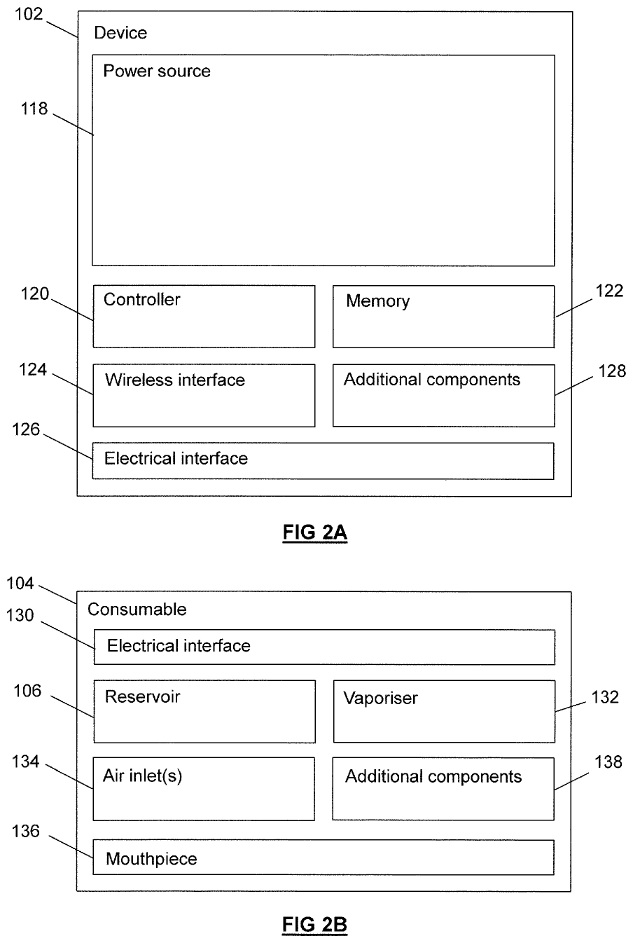

FIGS. 2A and 2B are schematic drawings of the device 102 and component 104. As is apparent from FIG. 2A, the device 102 includes a power source 118, a controller 120, a memory 122, a wireless interface 124, an electrical interface 126, and, optionally, one or more additional components 128.

The power source 118 is preferably a battery, more preferably a rechargeable battery. The controller 120 may include a microprocessor, for example. The memory 122 preferably includes non-volatile memory. The memory may include instructions which, when implemented, cause the controller 120 to perform certain tasks or steps of a method.

The wireless interface 124 is preferably configured to communicate wirelessly with another device, for example a mobile device, e.g. via Bluetooth®. To this end, the wireless interface 124 could include a Bluetooth® antenna. Other wireless communication interfaces, e.g. WiFi®, are also possible. The wireless interface 124 may also be configured to communicate wirelessly with a remote server.

The electrical interface 126 of the device 102 may include one or more electrical contacts. The electrical interface 126 may be located in a base of the aperture in the upper end 108 of the device 102. When the device 102 is physically coupled to the component 104, the electrical interface 126 is configured to transfer electrical power from the power source 118 to the component 104 (i.e. upon activation of the smoking substitute system 100).

The electrical interface 126 may also be used to identify the component 104 from a list of known components. For example, the component 104 may be a particular flavour and/or have a certain concentration of nicotine (which may be identified by the electrical interface 126). This can be indicated to the controller 120 of the device 102 when the component 104 is connected to the device 102. Additionally, or alternatively, there may be a separate communication interface provided in the device 102 and a corresponding communication interface in the component 104 such that, when connected, the component 104 can identify itself to the device 102.

The additional components 128 of the device 102 may comprise the light 116 discussed above.

The additional components 128 of the device 102 also comprises the charging connection 115 configured to receive power from the charging station (i.e. when the power source 118 is a rechargeable battery). This may be located at the lower end 110 of the device 102.

The additional components 128 of the device 102 may, if the power source 118 is a rechargeable battery, include a battery charging control circuit, for controlling the charging of the rechargeable battery. However, a battery charging control circuit could equally be located in a charging station (if present).

The additional components 128 of the device 102 may include a sensor, such as an airflow (i.e. puff) sensor for detecting airflow in the smoking substitute system 100, e.g. caused by a user inhaling through a mouthpiece portion 136 of the component 104. The smoking substitute system 100 may be configured to be activated when airflow is detected by the airflow sensor. This sensor could alternatively be included in the component 104. The airflow sensor can be used to determine, for example, how heavily a user draws on the mouthpiece or how many times a user draws on the mouthpiece in a particular time period.

The additional components 128 of the device 102 may include a user input, e.g. a button. The smoking substitute system 100 may be configured to be activated when a user interacts with the user input (e.g. presses the button). This provides an alternative to the airflow sensor as a mechanism for activating the smoking substitute system 100.

As shown in FIG. 2B, the component 104 includes the tank 106, an electrical interface 130, a vaporiser 132, one or more air inlets 134, a mouthpiece portion 136, and one or more additional components 138.

The electrical interface 130 of the component 104 may include one or more electrical contacts. The electrical interface 126 of the device 102 and an electrical interface 130 of the component 104 are configured to contact each other and thereby electrically couple the device 102 to the component 104 when the lower end 111 of the component 104 is inserted into the upper end 108 of the device 102 (as shown in FIG. 1A). In this way, electrical energy (e.g. in the form of an electrical current) is able to be supplied from the power source 118 in the device 102 to the vaporiser 132 in the component 104.

The vaporiser 132 is configured to heat and vaporise e-liquid contained in the tank 106 using electrical energy supplied from the power source 118. As will be described further below, the vaporiser 132 includes a heating filament and a wick. The wick draws e-liquid from the tank 106 and the heating filament heats the e-liquid to vaporise the e-liquid.

The one or more air inlets 134 are preferably configured to allow air to be drawn into the smoking substitute system 100, when a user inhales through the mouthpiece portion 136. When the component 104 is physically coupled to the device 102, the air inlets 134 receive air, which flows to the air inlets 134 along a gap between the device 102 and the lower end 111 of the component 104.

In operation, a user activates the smoking substitute system 100, e.g. through interaction with a user input forming part of the device 102 or by inhaling through the mouthpiece portion 136 as described above. Upon activation, the controller 120 may supply electrical energy from the power source 118 to the vaporiser 132 (via electrical interfaces 126, 130), which may cause the vaporiser 132 to heat e-liquid drawn from the tank 106 to produce a vapour which is inhaled by a user through the mouthpiece portion 136.

An example of one of the one or more additional components 138 of the component 104 is an interface for obtaining an identifier of the component 104. As discussed above, this interface may be, for example, an RFID reader, a barcode, a QR code reader, or an electronic interface which is able to identify the component. The component 104 may, therefore include any one or more of an RFID chip, a barcode or QR code, or memory within which is an identifier and which can be interrogated via the electronic interface in the device 102.

It should be appreciated that the smoking substitute system 100 shown in FIGS. 1A to 2B is just one exemplary implementation of a smoking substitute system. For example, the system could otherwise be in the form of an entirely disposable (single-use) system or an open system in which the tank is refillable (rather than replaceable).

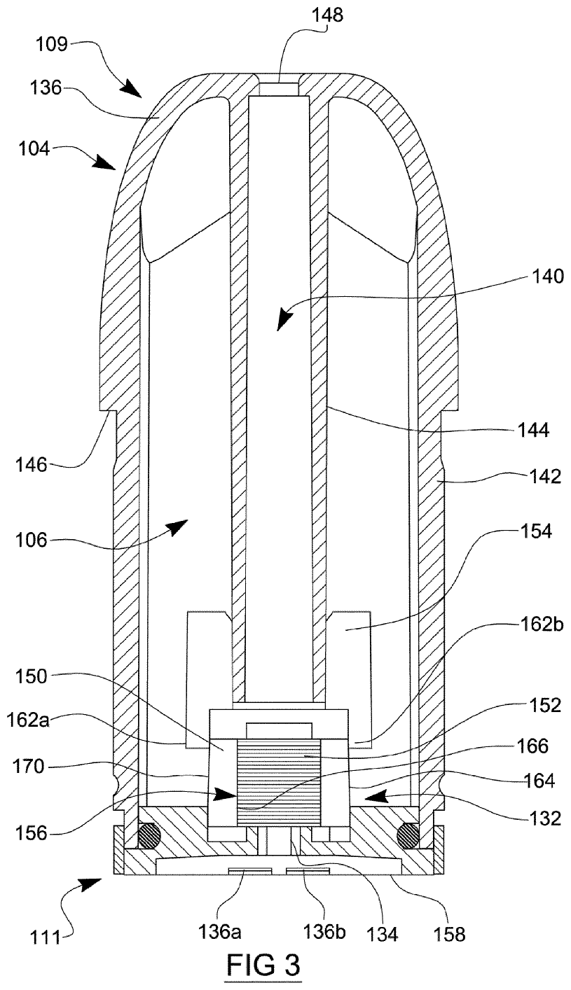

FIG. 3 is a section view of an example of the component 104 described above. The component 104 comprises a tank 106 for storing e-liquid, a mouthpiece portion 136 and a conduit 140 extending along a longitudinal axis of the component 104. In the illustrated embodiment the conduit 140 is in the form of a tube having a substantially circular transverse cross-section (i.e. transverse to the longitudinal axis).

The tank 106 surrounds the conduit 140, such that the conduit 140 extends centrally through the tank 106.

A tank housing 142 of the tank 106 defines an outer casing of the component 104, whilst a conduit wall 144 defines the conduit 140. The tank housing 142 extends from the lower end 111 of the component 104 to the mouthpiece portion 136 at the upper end 109 of the component 104. At the junction between the mouthpiece portion 136 and the tank housing 142, the mouthpiece portion 136 is wider than the tank housing 142, so as to define a lip 146 that overhangs the tank housing 142. This lip 146 acts as a stop feature when the component 104 is inserted into the device 102 (i.e. by contact with an upper edge of the device 102).

The tank 106, the conduit 140 and the mouthpiece portion 136 are integrally formed with each other so as to form a single unitary component and may e.g. be formed by way of an injection moulding process. Such a component may be formed of a thermoplastic material such as polypropylene.

The mouthpiece portion 136 comprises a mouthpiece aperture 148 defining an outlet of the conduit 140. The vaporiser 132 is fluidly connected to the mouthpiece aperture 148 and is located downstream of the inlet 134 of the component 104.

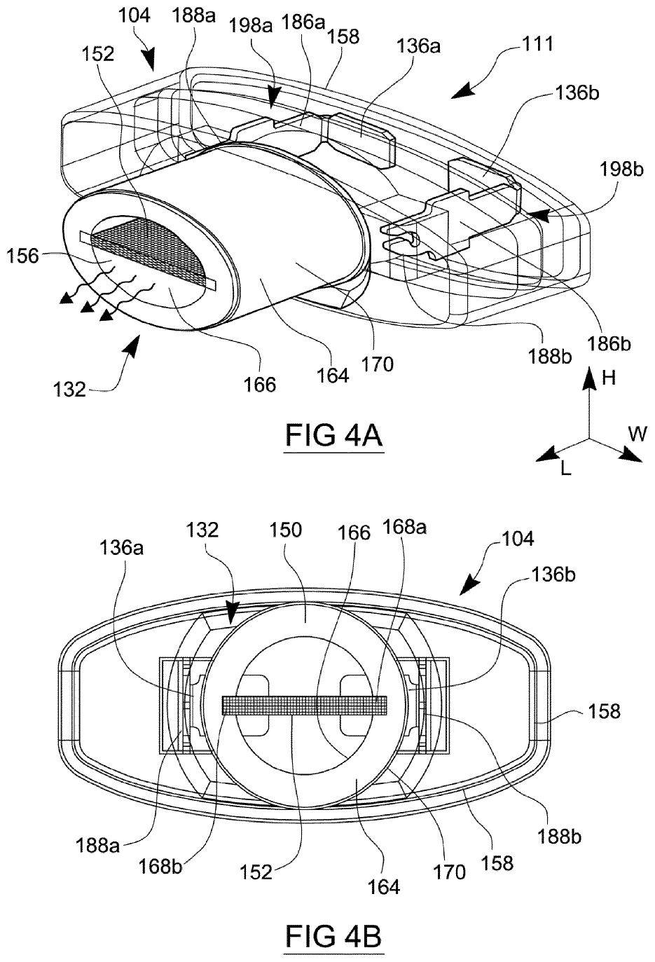

The vaporiser 132 comprises a porous wick 150 and a heating filament 152. The wick 150 has a tubular shape, as shown in FIGS. 4A and 4B, which defines the air flow path through the vaporiser 132. The wick 150 is formed of a ceramic material, thereby defining a tubular ceramic wick 150 of the vaporiser 132.

The heating element 152 comprises a sheet of absorbent, electrically-conductive material, which is arranged within the tubular ceramic wick 150 (i.e., within an axial bore 156 through the tubular wick), as is apparent from FIGS. 4A and 4B. The heating element 152 has opposing lateral edges that contact an inner circumferential surface 166 of the wick 150 to form line contacts between the heating element 152 and the wick 150.

The tubular ceramic wick 150 is mounted in an insert 158 that defines the lower end 111 of the component 104 that connects with the device 102. The insert 158 is inserted into an open lower end of the tank 106 so as to seal against the tank housing 142. The tubular ceramic wick 150 extends, in an axial direction of the wick 150, along a longitudinal axis of the component 104 towards the conduit 140. The wick 150 also extends, in a transverse direction of the wick 150, across the insert 158 between sidewalls 162a, 162b of an inner sleeve 154 which partially defines the tank 106, as shown in FIG. 3.

In this way, the inner sleeve 154 seals between the tank 106 and the conduit 140 (around the conduit wall 144). A perforated metal tube 170, or mesh, is arranged concentrically around the wick 150 so that an inner circumferential surface of the tube engages, or abuts, the outer circumferential surface 164 of the ceramic tubular wick 150. Perforations in the perforated tube 170 allow e-liquid to flow from the tank 106, through towards the circumferential sides of the wick 150. In this way, e-liquid is transported through the wick 150 (e.g. by capillary action) to the axial bore 156 of the wick 150, which is exposed to the airflow through the vaporiser 132.

The transported e-liquid is heated by the heating filament 152 (when activated e.g. by detection of inhalation), which causes the e-liquid to be vaporised and to be entrained in air flowing through the central bore 156 of the wick 150. This vaporised liquid may cool to form an aerosol in the conduit 140, which may then be inhaled by a user. Accordingly, the axial bore 156 of the ceramic tubular wick 150 defines a vaporising chamber of the component 104.

The insert 158 also accommodates the electrical interface 119 of the consumable component 102 comprising two electrical contacts 136a, 136b that are electrically connected to the heating filament 152. In particular, the electrical contacts 136a, 136b each comprise an elongate arm 186a, 186b which extends longitudinally, with respect to the component 104, towards the vaporiser 132, as shown in FIG. 4A. A deformable clip-on fastening 188a, 188b is provided at the distal end of each of the elongate arms 186a, 186b. Each clip-on fastening 188a, 188b is configured to mechanically attach directly to the heating element 152, thereby establishing an electrical connection. Each of the respective clip-on fastenings 188a, 188b, elongate arms 186a, 186b and electrical contacts 136a, 136b are integrally formed to define an electrical connector 198a of the component 104. In this way, when the consumable component 104 is engaged with the device 102, power can be supplied from the power source 118 of the device to the heating filament 152.

FIGS. 4A and 4B illustrate an exemplary arrangement of the consumable component 104 (i.e. aerosol delivery component) of FIG. 1A in more detail. As is apparent from these figures, the consumable component 104 is shown in a partially unassembled state to illustrate the arrangement of the vaporiser 132 within the component 104. In particular, a base of the wick 150 is mounted to the insert 158 and the wick 150 extends, in an axial direction of the wick 150, away from the insert 158.

As described above, the wick 150 is in the form of a ceramic tubular wick 150. The air flow between the inlet and outlet of the component 104 is directed through the axial bore 156 of the wick 150, as shown by the curved arrows shown in FIG. 4A. The wick 150 defines a vaporiser portion of the air flow path through the vaporiser 132. The wick 150 is formed of a porous aluminium nitride ceramic material. The wick 150 has a tubular form (e.g., an open cylinder), with a circular cross section comprising a diameter which is smaller than the axial length of the tube.

The heating element 152 comprises an absorbent, electrically-conductive material. The material comprises woven carbon fibres which have high electrical conductance, and are configured to tolerate the temperatures required to vaporise the aerosol precursor liquid. The woven carbon fibre material is configured with absorbent, and/or wicking, properties that control the flow of aerosol precursor liquid from the ceramic wick 150, and thereby enhances the formation of vaporised aerosol particles within vaporiser 132. According to an exemplary arrangement of the heating element 152, the absorbent, electrically-conductive material is configured, e.g. dimensioned such that it exhibits a resistance value of 1.4 Ohms under current-voltage conditions of 2 Amps, and a voltage range of between 3.7 to 4.2 Volts.

The wick 150 extends, in an axial direction of the wick 150, along a longitudinal axis (e.g., parallel to the length dimension L of the component 104, as shown in FIG. 4A) of the component 104. Thus, the wick extends in a direction parallel to the direction of airflow in the airflow path. This orientation of the wick 150 means less turbulent airflow through the vaporiser 132 which therefore increases the vapour delivery efficiency of the component 104.

The heating element 152 is arranged within the portion of the air flow path that is defined by the opening through the tubular wick 150. The heating element 152 is configured to contact an inner circumferential surface 166 of the wick 150, to enable a flow of liquid aerosol precursor from the wick to the heating element 152.

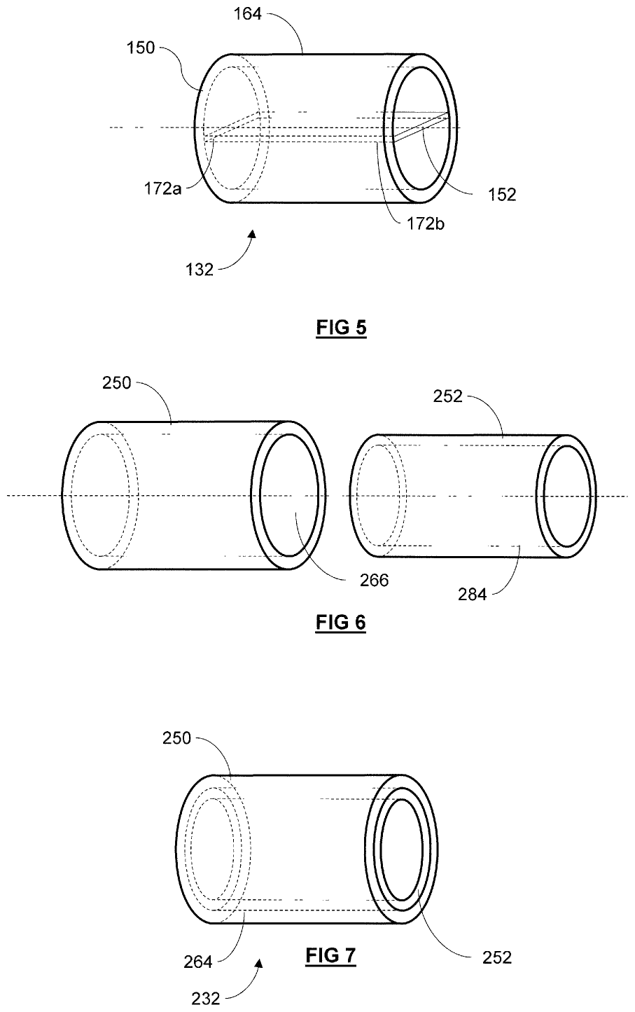

According to an exemplary arrangement, the heating element 152 is configured to be in the form of a planar sheet, as shown in FIGS. 4A, 4B and 5. The heating element 152 extends axially along the entire length of the wick 150 to increase the contact surface therewith. This leads to an increase in the vaporisation of aerosol precursor within the air flow path.

FIG. 5 is a perspective view of the vaporiser 132 shown in FIGS. 4A and 4B isolated from the remainder of the component 104. It is apparent from this view that the heating element 152 extends from an upstream end 172a to a downstream end 172b of the wick 150, thereby optimising the contact surface between the heating element 152 and the wick 150. The two longitudinal sides 168a, 168b of the planar sheet each form a line contact with the inner circumferential surface 166 of the wick 150. The sides 168a, 168b of the heating element 152 are also partially embedded within the wick 150, as shown in FIG. 4B, which further increases the contact surface between the wick 150 and the heating element 152.

The planar sheet of the heating element 152 has a length, a width and a depth. The length and the width are both substantially larger than the depth, and the length is greater than the width. The planar sheet is arranged in the air flow path such that a longitudinal direction of the planar sheet is parallel to the cylindrical axis of the wick 150. In this way, the planar sheet also extends transversely across the axial bore 156 of the wick 150. In this way, the planar sheet is arranged to bisect the air flow path through the wick 150. This evenly distributes the airflow either side of the planar sheet, which reduces turbulence of the air flow through the vaporiser 132.

FIGS. 6 and 7 illustrates a vaporiser 232 that is a variation of the vaporiser 132 shown, for example, in FIG. 5. Features in FIGS. 6 and 7, and the functioning thereof, that are the same or similar to those features already described with reference to FIGS. 4A, 4B and 5 are given similar reference numerals to those in FIGS. 4A, 4B and 5, but increased by 100, and will not be described in detail again. FIG. 6 shows the vaporiser 232 in an unassembled state in a heating element is separated from the tubular ceramic wick. FIG. 7 shows the vaporiser 232 in an assembled state, with the heating element 252 inserted within the tubular ceramic wick 250.

The illustrated vaporiser 232 differs in that the sheet of the heating element 252 is substantially curved. For example, the sheet is configured to follow the contour of at least a portion of the inner circumferential surface 266 of the wick 250.

According to this exemplary arrangement, the sheet of the heating element 252 forms a concentric tubular sheet (e.g., a concentric tube) which is entirely received within the wick 250, as shown in FIG. 7. As such, the heating element 252 defines a tubular sheet of absorbent, electrically-conductive material. The wick 250 and the tubular sheet are each formed separately and then assembled to make the vaporiser 132, as illustrated in FIG. 6.

An outer circumferential surface 284 of the concentric tubular sheet of the heating element 252 is arranged to abut the inner circumferential surface 266 of the wick 250. This arrangement provides an even greater contact surface between the heating element 252 and the wick 250, thereby increasing the vaporisation of aerosol precursor within the airflow through the vaporiser 232.

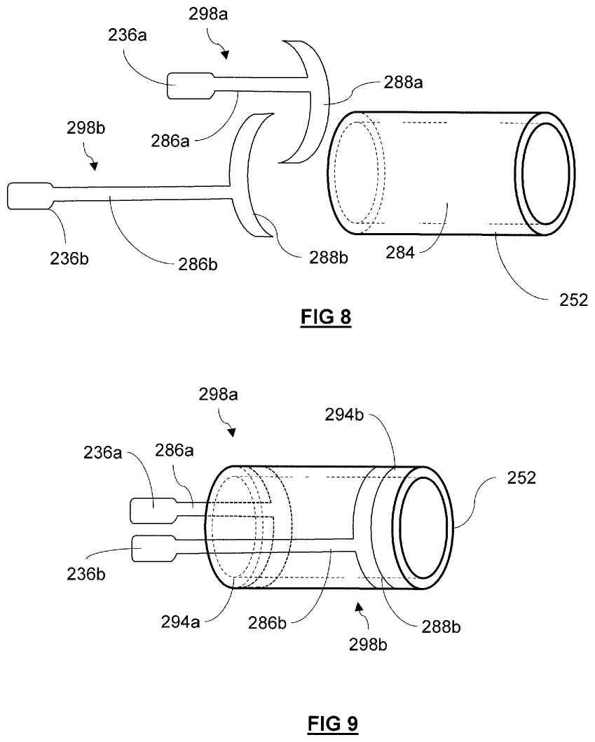

FIGS. 8 and 9 are perspective views of the heating element 252 of the vaporiser 232 shown in FIGS. 6 and 7, showing the tubular heating element 252 with a pair of electrical connectors 298a, 298b, arranged in an unassembled and an assembled state, respectively.

As is apparent from these figures, the electrical connectors 298a, 298b each comprise a clip-on fastening 288a, 288b which is configured to mechanically couple to the outer circumferential surface 284 of the tubular heating element 252. This provides a simple yet secure means of delivering power to the heating element 252. Each clip-on fastening 288a, 288b has a pair of curved arms which extend partially around the tubular heating element 252. The curved arms of the fastening are formed of an elastically deformable, electrically conductive material, to provide a secure electrical connection with the heating element 252.

A first electrical connector 288a is coupled to an upstream end 294a of the tubular heating element 252 and a second electrical connector 288b is coupled to a downstream end 294b, as shown in FIG. 9. This ensures electrical current is directed evenly along the entire length of the heating element 252.

Each of the electrical connectors 298a. 298b has an elongate arm 286a, 286b which extends, in an axial direction of the tubular heating element 252. When installed within the tubular ceramic wick 250, the elongate arms 286a, 286b extend between the outer circumferential surface 284 of the heating element 252 and the inner circumferential surface 266 of the wick 250.

While exemplary embodiments have been described above, many equivalent modifications and variations will be apparent to those skilled in the art when given this disclosure. Accordingly, the exemplary embodiments set forth above are considered to be illustrative and not limiting.

Throughout this specification, including the claims which follow, unless the context requires otherwise, the words “have”, “comprise”, and “include”, and variations such as “having”, “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means, for example, +/−10%.

The words “preferred” and “preferably” are used herein refer to embodiments of the invention that may provide certain benefits under some circumstances. It is to be appreciated, however, that other embodiments may also be preferred under the same or different circumstances. The recitation of one or more preferred embodiments therefore does not mean or imply that other embodiments are not useful, and is not intended to exclude other embodiments from the scope of the disclosure, or from the scope of the claims.

1. An aerosol delivery component comprising:
a vaporiser in fluid communication with a reservoir for storing a liquid aerosol precursor; and
an air flow path extending from an inlet of the component to an outlet of the component,
wherein the vaporiser comprises a tubular ceramic wick defining a vaporiser portion of the air flow path through the vaporiser, the vaporiser further comprising a heating element within the vaporiser portion of the air flow path wherein the heating element comprises a sheet of absorbent, electrically-conductive material.

2. An aerosol delivery component according to claim 1 wherein the sheet of absorbent, electrically-conductive material comprises a planar sheet.

3. An aerosol delivery component according to claim 2 wherein the planar sheet is arranged in the vaporiser portion of the air flow path such that a longitudinal dimension of the planar sheet is parallel to the cylindrical axis of the tubular ceramic wick.

4. An aerosol delivery component according to claim 3 wherein the planar sheet is arranged to bisect the vaporiser portion of the air flow path through the tubular ceramic wick.

5. An aerosol delivery component according to claim 1 wherein the sheet of absorbent, electrically-conductive material forms a concentric tubular sheet arranged within the tubular ceramic wick.

6. An aerosol delivery component according to claim 5 comprising an electrical connector, wherein the electrical connector comprises a clip-on fastening configured to mechanically couple the electrical connector to an outer circumferential surface of the tubular sheet.

7. An aerosol delivery component according to claim 6 wherein the electrical connector comprises an elongate arm which extends, in an axial direction of the tubular sheet, between an outer circumferential surface of the sheet and an inner circumferential surface of the tubular ceramic wick.

8. An aerosol delivery component according claim 1 wherein the sheet of absorbent, electrically-conductive material extends substantially along the entire axial length of the tubular ceramic wick.

9. An aerosol delivery component according to claim 1 wherein the absorbent, electrically-conductive material comprises carbon fibres.

10. An aerosol delivery component according to claim 9, wherein the carbon fibres are configured to form a woven material.

11. An aerosol delivery component according to claim 1 wherein the tubular ceramic wick extends, in an axial direction of the tubular ceramic wick, along a longitudinal axis of the aerosol delivery component.

12. An aerosol delivery component according to claim 11 wherein the component comprises a perforated tube arranged concentrically around the tubular ceramic wick.

13. An aerosol delivery component according to claim 12 wherein the perforated tube is formed from a metallic alloy material.

14. An aerosol delivery component according to claim 1 which is a consumable component for receipt in a smoking substitute device.

15. An aerosol-delivery system comprising a component according to claim 1 and a device comprising a power source.
